(19) United States
(12) Patent Application Publication
(10) Pub. No.: US 2021/0310626 A1
(43) Pub. Date: Oct. 7, 2021

(54) High Mast Lighting Pole Assembly with Leveling System and Stabilizing System

(71) Applicant: Structural and Steel Products, Inc., Fort Worth, TX (US)

(72) Inventors: William K. Shoemaker, Fort Worth, TX (US); Juan Gutierrez, Fort Worth, TX (US)

(73) Assignee: Structural and Steel Products, Inc., Fort Worth, TX (US)

(21) Appl. No.: 17/304,333

(22) Filed: Jun. 18, 2021

Related U.S. Application Data
(63) Continuation of application No. PCT/US2019/067248, filed on Dec. 18, 2019.
(60) Provisional application No. 62/782,006, filed on Dec. 19, 2018.

(51) Int. Cl. F21S 8/08; F21V 21/38

(52) U.S. Cl. CPC F21S 8/085; F21V 21/38

(57) ABSTRACT

A lighting pole assembly comprises a mast extending vertically; a headframe positioned at the top of the mast; a ring platform configured to be raised and lowered with respect to the mast, and configured to removably attached to or latch with the headframe; an arm array configured to hold one or more lights; a plurality of cables configured to attach to the ring platform; and a winch attached to the plurality of cables configured to move the cables to change the position of the ring platform with respect to the headframe.

### CROSS-REFERENCE TO RELATED APPLICATIONS

The present application is a continuation of PCT/US2019/067248 that was filed on Dec. 18, 2019 and published as WO 2020/132116 A1 which is a continuation of and claims priority to U.S. Provisional Patent Application Ser. No. 62/782,006 filed Dec. 19, 2018 by William K. Shoemaker, et al. and entitled “High Mast Lighting Pole Assembly with Leveling System and Stabilizing System,” both of which are incorporated herein by reference as if reproduced in their entirety.

### STATEMENT REGARDING FEDERALLY SPONSORED RESEARCH OR DEVELOPMENT

Not applicable.

### REFERENCE TO A MICROFICHE APPENDIX

Not applicable.

### SUMMARY

In an embodiment, a lighting pole assembly comprises a mast extending vertically; a headframe positioned at the top of the mast; a ring platform configured to be raised and lowered with respect to the mast, and configured to removably attached to or latch with the headframe; an arm array configured to hold one or more lights; a plurality of cables configured to attach to the ring platform; and a winch attached to the plurality of cables configured to move the cables to change the position of the ring platform with respect to the headframe.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates an exploded view of a lighting pole assembly according to an embodiment of the disclosure.

FIG. 2 illustrates a partially exploded view of a headframe according to an embodiment of the disclosure.

FIG. 3 illustrates a partially exploded view of a ring platform according to an embodiment of the disclosure.

FIG. 4 illustrates a bottom view of a cable separator according to an embodiment of the disclosure.

FIG. 5 illustrates a top view of a cable separator according to an embodiment of the disclosure.

FIG. 6 illustrates a perspective view of a latch indicator system according to an embodiment of the disclosure.

FIG. 7 illustrates another perspective view of a latch indicator system according to an embodiment of the disclosure.

FIGS. 8A-8E illustrate a process of employing a latch indicator system according to an embodiment of the disclosure.

FIG. 9 illustrates a pole guide according to an embodiment of the disclosure.

FIG. 10 illustrates a pole guide installed onto a pole and ring platform according to an embodiment of the disclosure.

FIG. 11 illustrates another view of the pole guide of FIG. 9 according to an embodiment of the disclosure.

FIG. 12 illustrates another view of the pole guide installed onto a pole and ring platform according to an embodiment of the disclosure.

FIGS. 13A-13B illustrate detailed views of a spring assembly of a pole guide according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or “approximately” or the like, when used with a number, may mean that specific number, or alternatively, a range in proximity to the specific number, as understood by persons of skill in the art field (for example, ±10%); and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

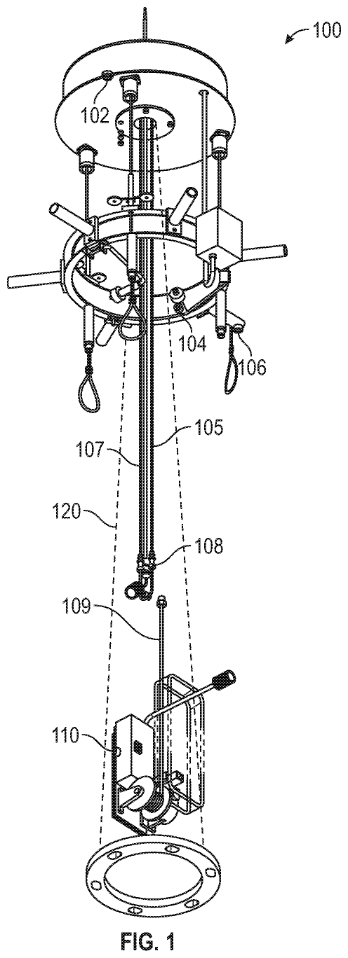

Referring now to FIG. 1, an overall lighting pole assembly 100 is shown, wherein the lighting pole assembly 100 may comprise a headframe 102 configured to adjustably and/or removably attach to a ring platform 104, wherein the ring platform 104 may comprise an arm array 106. The arm array 106 may be configured to attach to a plurality of lights. The lighting pole assembly 100 may also comprise one or more cables 105, 107, and 109 (wherein for example, tension cable 105 and power cable 107 may be attached via a cable transition 108 to a single winch cable 109) configured to attach the headframe 102 and/or ring platform 104 to a winch system (or plate) 110. In some embodiments, the cable transition 108 and/or the winch system 110 may be configured to be housed within a mast 120 (shown as transparent, which may also be called a pole).

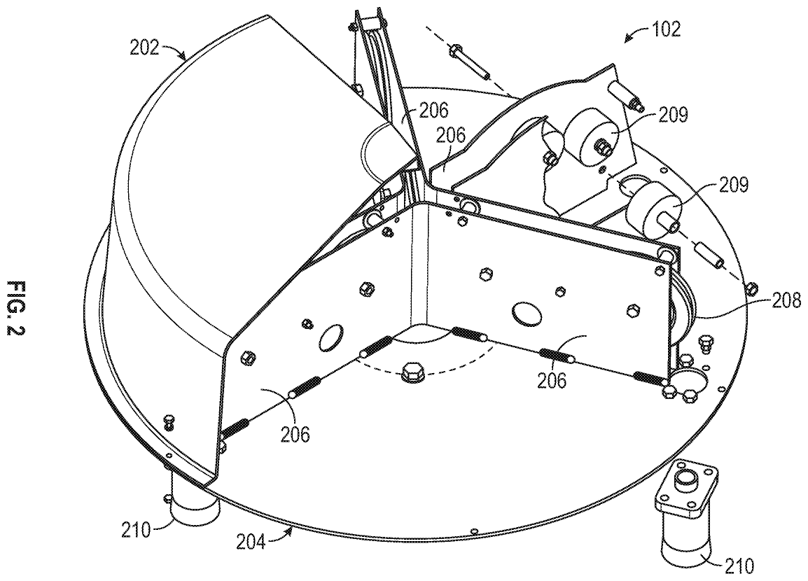

FIG. 2 illustrates a detailed view of the headframe 102, where a dome cover 202 of the headframe 102 may be shown in partial cutout. The headframe 102 may comprise a weldment assembly 204, where the dome cover 202 is configured to attach to the weldment assembly 204. The headframe 102 may comprise one or more cable channels 206, sheaves 208, and/or rollers 209 configured to direct, guide, and/or separate the cables (which may be part of the cable transition 108 shown in FIG. 1). The cables may comprise wire cables (and/or cords) and power cables. The headframe 102 may comprise one or more latch cam(s) 210. In some embodiments, the headframe 102 may comprise a plurality of latch cams 210 positioned about the perimeter of the weldment assembly 204.

FIG. 3 illustrates a detailed view of the ring platform 104, where some of the elements are partially exploded for clarity. The ring platform 104 may comprise a junction box 320 configured to provide/direct power to the elements of the overall lighting pole assembly 100. In some embodiments the junction box 320 may attach to the power cable 107 described above. The ring platform 104 may comprise one or more centering or bumper arms 322 positioned within the ring platform 104 and configured to contact the mast 120 when the ring platform 104 is assembled within the lighting pole assembly 100.

The ring platform 104 may comprise at least one latch shaft 310 (which may be configured to interface with the latch cam 210 of the headframe 102, for example). The latch shaft 310 may comprise a through-hole configured to allow a cable or wire 105 to pass through to connect to a spring assembly 302. Referring back to FIG. 1, the tension cable 105 may also pass through the headframe 102 and down through the center of the headframe 102 to be attached to and controlled by the winch 110, wherein the tension cable 105 (via the winch 110) may be configured to move the ring platform 104 upward toward the headframe 102 or downward away from the headframe 102. The tension cable 105 may pass through a spring housing 303 of the spring assembly 302 as well as a compression spring 304. The tension cable 105 may pass through a bearing collar 305 and ultimately attach to a cable strand vice 306, wherein the cable strand vice 306 may fixedly hold the tension cable 105 and may press against the compression spring 304 when the tension cable 105 is pulled against the spring 304.

Referring to FIGS. 2 and 3, in some embodiments, the ring platform 104 may be raised by one or more tension cables 105 attached to the winch 110 to contact the headframe 102. The latch shaft(s) 310 may fit into the latch cam(s) 210, wherein one or more projections on the latch shaft 310 may interface with one or more channels within the latch cam 210 to removably lock the latch shaft 310 within the latch cam 210. In some embodiments, the latch shaft 310 may rotate with respect to the latch cam 210 and/or the ring platform 104 itself. The latch indication flag(s) 312 may be fixedly attached to the latch shaft 310, causing them to rotate when the latch shaft 310 rotates. Therefore, the position of the latch indication flag(s) 312 may be viewed by a user below the ring platform 104 to determine at which position the latch shaft 310 is within the latch cam 210 (e.g., locked, latched or unlocked, unlatched or an intermediate position). If the ring platform 104 is not level with the headframe 102, the spring assemblies 302 may allow each of the latch shafts 310 to be pulled into each of the latch cams 210 to latch correctly and position the ring platform 104 level with the headframe 102.

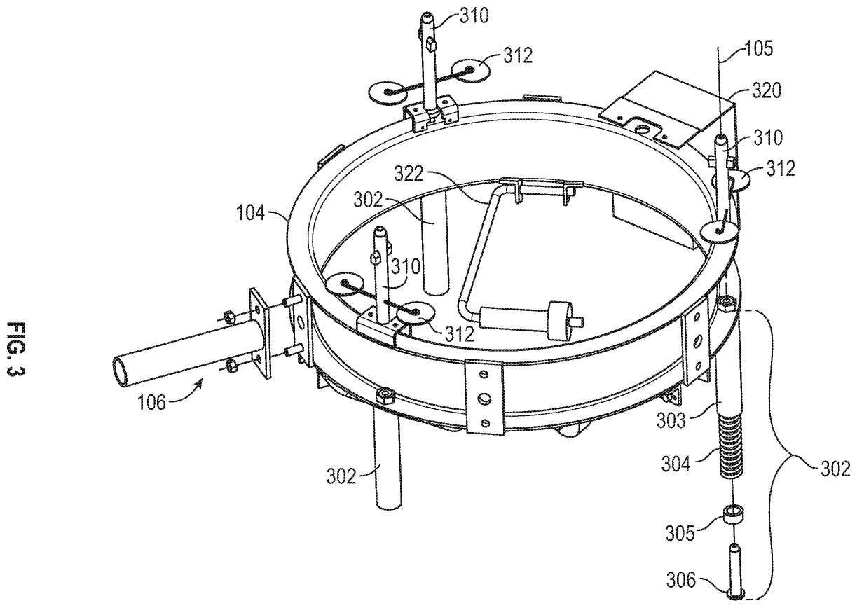

Referring to FIG. 4, an exemplary weldment assembly 204 of a headframe 102 is shown, wherein the weldment assembly 204 comprises a cable separator 402. The cable separator 402 may comprise an opening 404 through the bottom surface of the weldment assembly 204. One or more tension cables 105 (or wire ropes) and/or at least one power cable 107 (or electrical cord) may extend through the opening from a top surface to the bottom surface of the weldment assembly 204. In some embodiments, the tension cables 105 and/or power cable 107 may extend from channels 206 (shown in FIG. 2) on the top surface of the weldment assembly 204. The cable separator 402 may also comprise one or more rods 406 and 408 configured to divide the opening 404 into sections, and wherein each of the tension cables 105 and/or power cable 107 is positioned within a separate section.

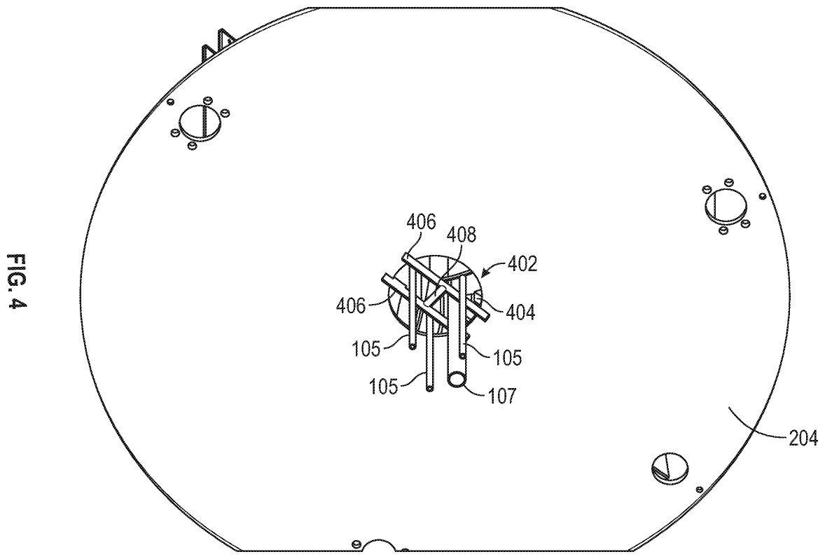

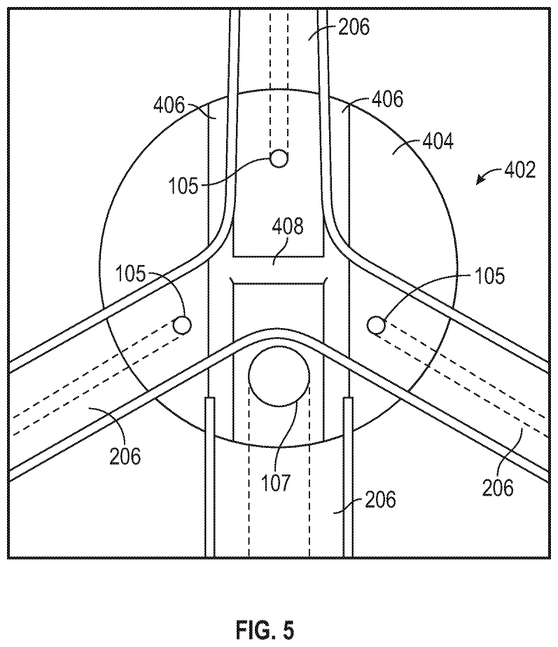

FIG. 5 illustrates a detailed top down view of the cable separator 402 and well as the channels 206 configured to hold and/or direct the tension cables 105 and/or power cable 107. The channels 206 in combination with the rods 406 and 408 may create sections within the opening 404 to divide the tension cables 105 and power cable 107 from one another. This may prevent interaction between the tension cables 105 and/or power cable 107 that could cause damage to the tension cables 105 and/or power cable 107. The rods 406 and 408 may be welded or otherwise attached to the bottom surface of the weldment assembly 204.

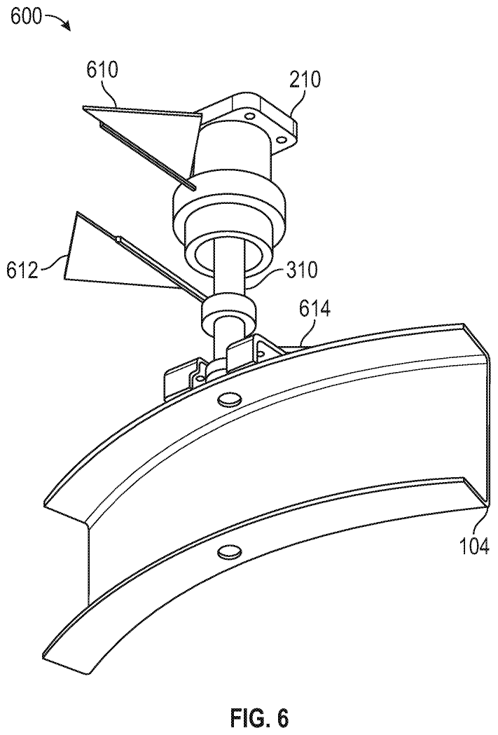

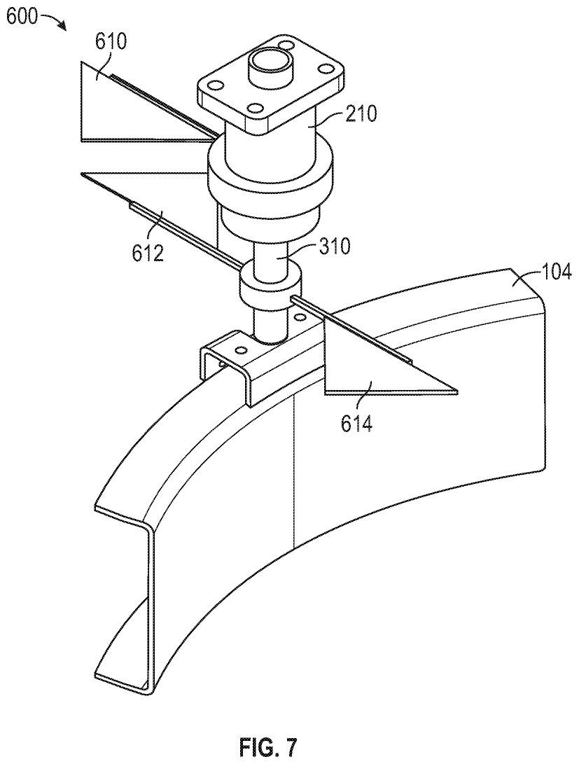

Referring now to FIGS. 6 and 7, an exemplary embodiment of an indicator system 600 is shown. The indicator system 600 may comprise one or more shaft flags 612 and 614 configured to attach to the latch shaft 310 (which is attached to the ring platform 104), wherein the shaft flags 612 and 614 may be similar to the latch indication flag 312 described in FIG. 3. The indicator system 600 may also comprise at least one cam flag 610 configured to attach to the latch cam 210 (which is attached to the headframe, not shown). In some embodiments, the latch cam 210 may be fixedly attached to the headframe, and the latch shaft 310 may be configured to rotate with respect to the ring platform 104 and/or latch cam 210. Therefore, the cam flag 610 may be in a fixed position relative to the headframe and the ring platform 104, while the shaft flags 612 and 614 may be configured to rotate with the rotation of the latch shaft 310. In some embodiments, the cam flag 610 may be a different color than the shaft flags 612 and 614 so that a user may easily identify the flags from a distance. In some embodiments, the position of the shaft flags 612 and 614 with respect to the cam flag 610 may indicate the position of the latch shaft 310 within the latch cam 210.

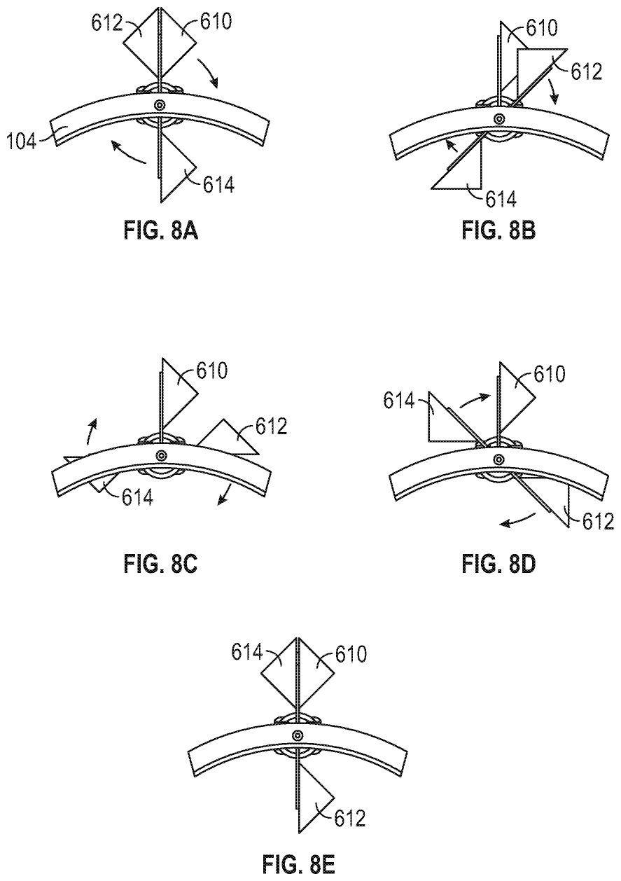

For example, FIGS. 8A-8E illustrates a process or method of latching and unlatching the latch shaft 310 with the latch cam 210 and the positions of the flags 610, 612, and 614 at each step. FIGS. 8A-8E illustrate a bottom view of the ring platform 104, illustrating how the system may be viewed by a user on the ground under the ring platform.

In FIG. 8A, the latch shaft 310 may be in a “latched” position within the latch cam 210, and the flags 612 and 610 may be aligned with one another. In FIG. 8B, the latch shaft 310 may be raised with respect to the latch cam 210 (for example by pulling the cables with the winch, as described above). The may cause the latch shaft 310, and therefore the shaft flags 612 and 614, to rotate to a “transition” position between latched and unlatched. The “transition” position shown in FIG. 8B may be a transition position before the latch shaft is unlatched. The shaft flag 612 may be misaligned and overlapping the cam flag 610. Then, in FIG. 8C, the latch shaft 310 may be lowered with respect to the latch cam 210, causing the latch shaft 310 to rotate to an “unlatched” position, where the latch shaft 310 may now be free to be removed from contact with the latch cam 210, thereby allowing the ring platform to be lowered with respect to the headframe. The shaft flags 612 and 614 may be approximately perpendicular to the cam flag 610, and may be at least partially hidden by the ring platform 104.

To position the latch shaft 310 back into a latched position with the latch cam 210, in FIG. 8D, the latch shaft 310 may be raised within the latch cam 210, causing the latch shaft 310 to rotate again within the latch cam 210 to a “transition” position, and causing the shaft flags 612 and 614 to rotate with respect to the cam flag 610. The “transition” position shown in FIG. 8D may be a transition position before the latch shaft is latched. Then, in FIG. 8E, the latch shaft 310 may be lowered into a “latched” position with the latch cam 210, thereby rotating the shaft flags 612 and 614 into the aligned position (similar to FIG. 8A) with the cam flag 610. Because the latch shaft 310 rotates in one direction, the shaft flags 612 and 614 may also rotate in one direction and may alternate which of the shaft flags 612 and 614 is aligned with the cam flag 610.

The steps from FIG. 8A to FIG. 8C illustrate unlatching the latch shaft from the latch cam, while the steps from FIG. 8C to FIG. 8E illustrate latching the latch shaft to the latch cam.

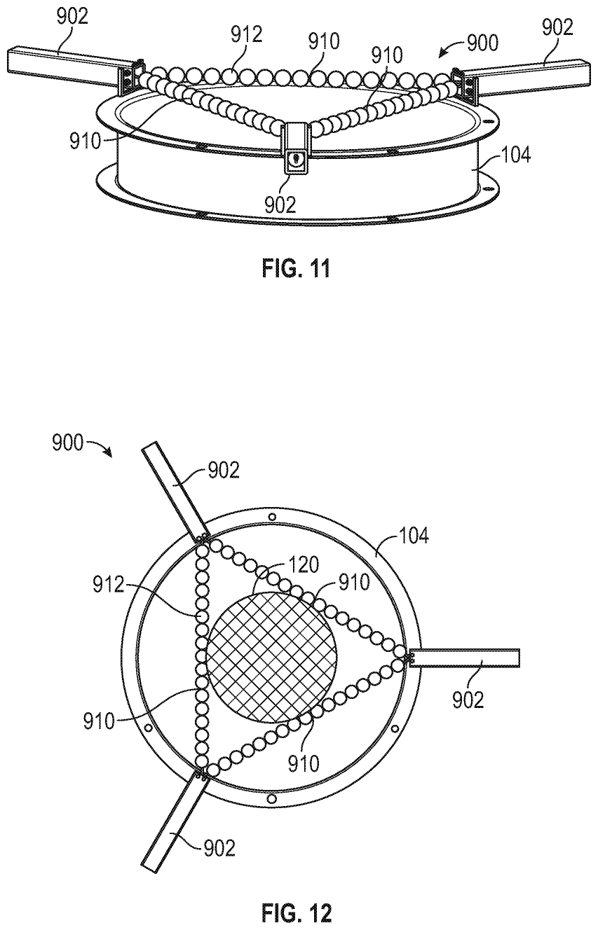

Referring to FIGS. 9-13B, an exemplary embodiment of a pole guide 900 is shown, wherein the pole guide 900 may be configured to attach to a ring platform 104 (as described above) and may be configured to create a space between the ring platform 104 and a mast or pole 120. The pole guide 900 may comprise one or more spring assemblies 902 configured to connect to the ring platform 104. The spring assemblies 902 may be connected via cables 910, wherein the cables 910 may comprise a spacer material 912 fitted around the cables 910 to protect the cables 910 and the pole 120. In the embodiment shown in FIGS. 9-13B, the spacer material may comprise circular spacers 912 fitted onto the cable 910. The spring assemblies 902 may allow pressure to be applied to the cables 910 and movement of the cables 910 while ensuring there is no contact between the ring platform 104 and the pole 120. In some embodiments, the pole guide 900 may be installed onto new ring platforms 104, while in other embodiments, the pole guide 900 may be attached to existing ring platforms 104 that are in use with a lighting pole assembly.

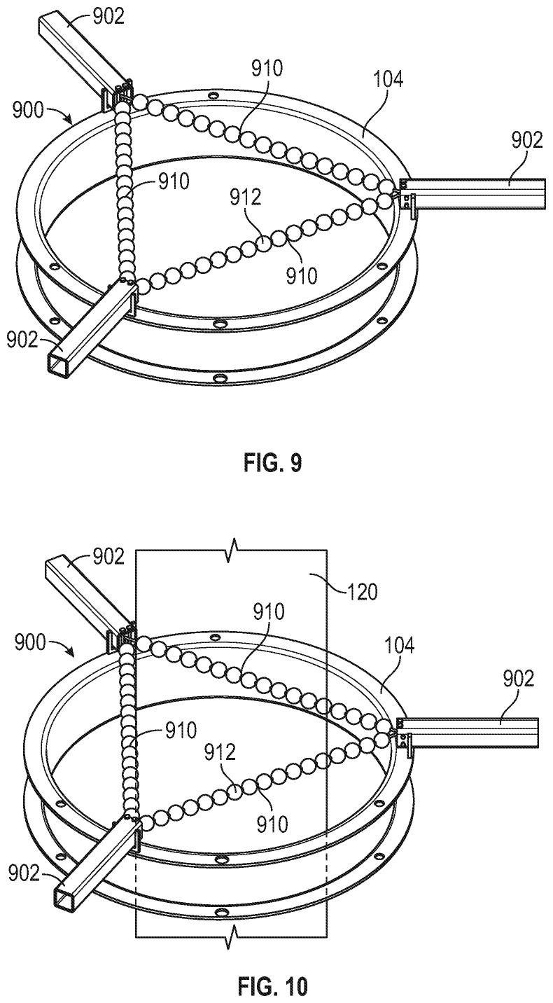

As shown in FIG. 10 and FIG. 12, the pole 120 (or mast) may fit between the plurality of cables 910, and the cables 910 may comprise flexibility due to the attachment between the cables 910 and the spring assemblies 902.

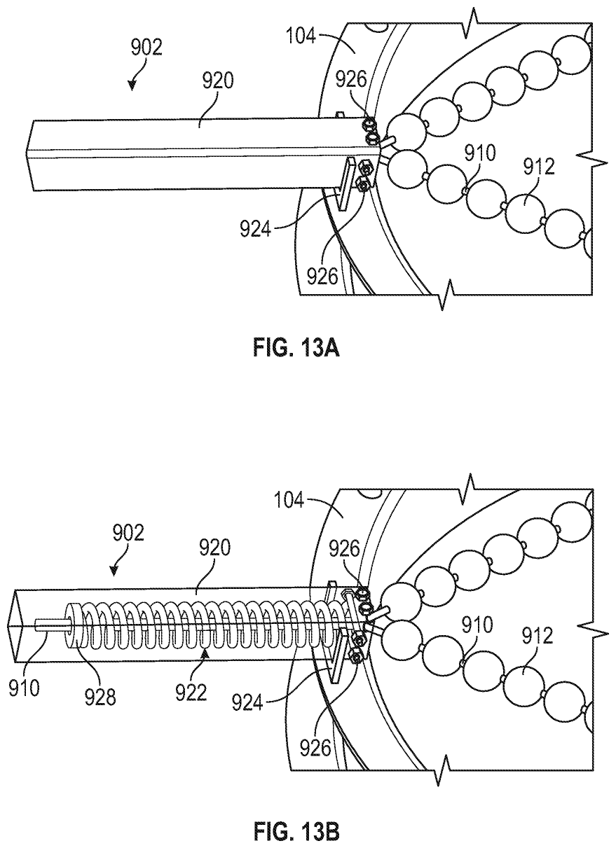

FIGS. 13A and 13B show detailed views of the spring assembly 902, wherein one spring assembly 902 is shown, but each of a plurality of spring assemblies 902 may comprise similar elements. The spring assembly 902 may comprise a housing 920 configured to cover a compression spring 922. The housing 920 may comprise a connector 924 configured to attach to the ring platform 104. The cables 910 may fit into the housing near the connection between the housing 920 and the ring platform 104, and the cables 910 may extended through the spring 922. In some embodiments, the cables 910 may be secured to one end of the spring 922 via a bearing 928. In some embodiments, the cables 910 may be directed into the housing 920 via one or more bolts 926 which provide a rounded and/or friction-reduced contact surface for guiding cables 910 into and/or out of the housing 920. In use, the cables 910 may be pressed by the pole and therefore may pull against the compression spring 922. The spring 922 may comprise a rigidity configured to allow for movement of the cables 910 up to a point where the spring 922 prevents the pole from contacting the ring platform.

Disclosed herein is a first embodiment of a lighting pole assembly comprising a mast extending vertically; a headframe positioned at the top of the mast; a ring platform configured to be raised and lowered with respect to the mast, and configured to removably attached to or latch with the headframe; an arm array configured to hold one or more lights; a plurality of cables configured to attach to the ring platform; and a winch attached to the plurality of cables configured to move the cables to change the position of the ring platform with respect to the headframe.

Disclosed herein is a second embodiment a lighting pole assembly comprising a mast extending vertically; a headframe positioned at the top of the mast; a ring platform configured to be raised and lowered with respect to the mast, and configured to removably attached to or latch with the headframe; an arm array configured to hold one or more lights; a plurality of cables configured to attach to the ring platform; a winch attached to the plurality of cables configured to move the cables to change the position of the ring platform with respect to the headframe; one or more latch cams fixedly attached to the headframe; and one or more corresponding latch shafts attached to the ring platform, configured to rotate with respect to the ring platform, and configured to removably latch within the latch cams.

Disclosed herein is a third embodiment a lighting pole assembly comprising a mast extending vertically; a headframe positioned at the top of the mast; a ring platform configured to be raised and lowered with respect to the mast, and configured to removably attached to or latch with the headframe; an arm array configured to hold one or more lights; a plurality of cables configured to attach to the ring platform; a winch attached to the plurality of cables configured to move the cables to change the position of the ring platform with respect to the headframe; one or more latch cams fixedly attached to the headframe; one or more corresponding latch shafts attached to the ring platform, configured to rotate with respect to the ring platform, and configured to removably latch within the latch cams; and at least one indicator flag attached to the latch shaft(s) configured to indicate the position of the latch shaft with respect to the latch cam to a user.

Disclosed herein is a fourth embodiment a lighting pole assembly comprising a mast extending vertically; a headframe positioned at the top of the mast; a ring platform configured to be raised and lowered with respect to the mast, and configured to removably attached to or latch with the headframe; an arm array configured to hold one or more lights; a plurality of cables configured to attach to the ring platform; a winch attached to the plurality of cables configured to move the cables to change the position of the ring platform with respect to the headframe; one or more latch cams fixedly attached to the headframe; one or more corresponding latch shafts attached to the ring platform, configured to rotate with respect to the ring platform, and configured to removably latch within the latch cams; at least one indicator flag attached to the latch shaft(s) configured to indicate the position of the latch shaft with respect to the latch cam to a user; a first shaft flag attached to the latch shaft, configured to rotate with the latch shaft; a second shaft flag attached to the latch shaft, configured to rotate with the latch shaft; and a cam flag attached to the latch cam, wherein the rotation of the shaft flag(s) and the position of the shaft flag(s) with respect to the cam flag indicates the position of the latch shaft with respect to the latch cam to a user.

Disclosed herein is a fifth embodiment of a lighting pole assembly comprising a mast extending vertically; a headframe positioned at the top of the mast; a ring platform configured to be raised and lowered with respect to the mast, and configured to removably attached to or latch with the headframe; an arm array configured to hold one or more lights; a plurality of cables configured to attach to the ring platform; a winch attached to the plurality of cables configured to move the cables to change the position of the ring platform with respect to the headframe; and a cable separator incorporated into the headframe, configured to separate the plurality of cables from each other, wherein at least one of the cables comprises a power cable.

Disclosed herein is a sixth embodiment of a lighting pole assembly comprising a mast extending vertically; a headframe positioned at the top of the mast; a ring platform configured to be raised and lowered with respect to the mast, and configured to removably attached to or latch with the headframe; an arm array configured to hold one or more lights; a plurality of cables configured to attach to the ring platform; a winch attached to the plurality of cables configured to move the cables to change the position of the ring platform with respect to the headframe; and a cable separator incorporated into the headframe, configured to separate the plurality of cables from each other, wherein at least one of the cables comprises a power cable, wherein the cable separator comprises one or more rods attached to a bottom surface of the headframe.

Disclosed herein is a seventh embodiment of a lighting pole assembly comprising a mast extending vertically; a headframe positioned at the top of the mast; a ring platform configured to be raised and lowered with respect to the mast, and configured to removably attached to or latch with the headframe; an arm array configured to hold one or more lights; a plurality of cables configured to attach to the ring platform; a winch attached to the plurality of cables configured to move the cables to change the position of the ring platform with respect to the headframe; and a cable separator incorporated into the headframe, configured to separate the plurality of cables from each other, wherein at least one of the cables comprises a power cable, wherein the cable separator comprises one or more channels attached to a top surface of the headframe.

Disclosed herein is an eighth embodiment of a lighting pole assembly comprising a mast extending vertically; a headframe positioned at the top of the mast; a ring platform configured to be raised and lowered with respect to the mast, and configured to removably attached to or latch with the headframe; an arm array configured to hold one or more lights; a plurality of cables configured to attach to the ring platform; a winch attached to the plurality of cables configured to move the cables to change the position of the ring platform with respect to the headframe; and a pole guide attached to the ring platform and configured to separate the ring platform and the mast.

Disclosed herein is a ninth embodiment of a lighting pole assembly comprising a mast extending vertically; a headframe positioned at the top of the mast; a ring platform configured to be raised and lowered with respect to the mast, and configured to removably attached to or latch with the headframe; an arm array configured to hold one or more lights; a plurality of cables configured to attach to the ring platform; a winch attached to the plurality of cables configured to move the cables to change the position of the ring platform with respect to the headframe; and a pole guide attached to the ring platform and configured to separate the ring platform and the mast, wherein the pole guide comprises a plurality of spring assemblies attached to a plurality of cables, and wherein the mast is configured to fit within a space created by the cables.

Disclosed herein is a tenth embodiment of a lighting pole assembly comprising a mast extending vertically; a headframe positioned at the top of the mast; a ring platform configured to be raised and lowered with respect to the mast, and configured to removably attached to or latch with the headframe; an arm array configured to hold one or more lights; a plurality of cables configured to attach to the ring platform; a winch attached to the plurality of cables configured to move the cables to change the position of the ring platform with respect to the headframe; a pole guide attached to the ring platform and configured to separate the ring platform and the mast, wherein the pole guide comprises a plurality of spring assemblies attached to a plurality of cables, and wherein the mast is configured to fit within a space created by the cables; and spacer material configured to fit over the cables.

Disclosed herein is are additional embodiments of a lighting pole assembly as disclosed herein in the specification and/or drawings.

Disclosed herein are methods of forming the lighting pole assemblies of the first through tenth embodiments detailed above.

Disclosed herein are additional methods of forming a lighting pole assembly as disclosed herein in the specification and/or drawings.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A lighting pole assembly comprising
a mast extending vertically;
a headframe positioned at the top of the mast;
a ring platform configured to be raised and lowered with respect to the mast, and configured to removeably attach to or latch with the headframe;
an arm array configured to hold one or more lights;
a plurality of cables configured to attach to the ring platform; and
a winch attached to the plurality of cables configured to move the cables to change the position of the ring platform with respect to the headframe.

2. The lighting pole assembly of claim 1, further comprising:
one or more latch cams fixedly attached to the headframe;
one or more corresponding latch shafts attached to the ring platform, configured to rotate with respect to the ring platform, and configured to removably latch within the latch cams.

3. The lighting pole assembly of claim 2, further comprising at least one indicator flag attached to the latch shaft(s) configured to indicate the position of the latch shaft with respect to the latch cam to a user.

4. The lighting pole assembly of claim 3, further comprising:
a first shaft flag attached to the latch shaft, configured to rotate with the latch shaft;
a second shaft flag attached to the latch shaft, configured to rotate with the latch shaft; and
a cam flag attached to the latch cam, wherein the rotation of the shaft flag(s) and the position of the shaft flag(s) with respect to the cam flag indicates the position of the latch shaft with respect to the latch cam to a user.

5. The lighting pole assembly of claim 1, further comprising a cable separator incorporated into the headframe, configured to separate the plurality of cables from each other, wherein at least one of the cables comprises a power cable.

6. The lighting pole assembly of claim 5, wherein the cable separator comprises one or more rods attached to a bottom surface of the headframe.

7. The lighting pole assembly of claim 5, wherein the cable separator comprises one or more channels attached to a top surface of the headframe.

8. The lighting pole assembly of claim 1, further comprising a pole guide attached to the ring platform and configured to separate the ring platform and the mast.

9. The lighting pole assembly of claim 8, wherein the pole guide comprises a plurality of spring assemblies attached to a plurality of cables, and wherein the mast is configured to fit within a space created by the cables.

10. The lighting pole assembly of claim 9, further comprising spacer material configured to fit over the cables.
